(19) United States
(12) Patent Application Publication
(10) Pub. No.: US 2026/0197552 A1
(43) Pub. Date: Jul. 9, 2026

(54) IMAGING APPARATUS CAPABLE OF ESTIMATING IMAGING PARAMETER, METHOD OF CONTROLLING IMAGING APPARATUS, AND STORAGE MEDIUM STORING PROGRAM

(71) Applicant: CANON KABUSHIKI KAISHA, Tokyo (JP)

(72) Inventor: KEI OCHIAI, Kanagawa (JP)

(21) Appl. No.: 19/437,328

(22) Filed: Dec. 31, 2025

(30) Foreign Application Priority Data
Jan. 6, 2025 (JP) 2025-001666

(51) Int. Cl. H04N 23/60; G01C 3/08; G01C 3/32; H04N 23/611; H04N 23/67; H04N 23/73

(52) U.S. Cl. CPC H04N 23/64; G01C 3/08; G01C 3/32; H04N 23/611; H04N 23/67; H04N 23/73

(57) ABSTRACT

An imaging apparatus captures an image of a subject, outputs a first defocus range corresponding to a first portion of the subject and a second defocus range corresponding to a second portion of the subject, and sets an imaging condition with respect to the subject based on the first defocus range at a first time, the first defocus range at a second time, the second defocus range at the first time, and the second defocus range at the second time.

### BACKGROUND

### Field of the Technology

The present disclosure relates to an imaging apparatus that estimates an imaging parameter, an imaging method, and a storage medium storing a program.

### Description of the Related Art

An imaging apparatus configured to, in continuous imaging to continuously perform imaging multiple times or moving-image capturing, detect distance information from each of a plurality of focus detection areas in an area including a subject and thereby perform focus adjustment so as to focus on a main subject is known.

Additionally, an imaging apparatus that controls an aperture stop and a focus ring so that a plurality of specific parts of a subject falls within a depth of field is also known. For example, Japanese Patent Application Laid-Open No. 2022-137760 describes an imaging apparatus that controls an aperture stop and a focus ring based on distance information regarding each of a plurality of specific parts of a subject.

For example, in a situation where a user wants to put a focus on the face of a human figure as the subject, there is a case where the arm or hand of the human figure hides the face. In a case where the arm hides the face, a face area includes an area in which the face does not exist (that is, an area of the arm hiding the face), and a focus detection result in the face area continuously changes from the face toward the arm. In this case, according to the technique described in Japanese Patent Application Laid-Open No. 2022-137760, it is difficult to put a focus on the face while preventing the influence of the arm.

In a technique described in Japanese Patent Application Laid-Open No. 2012-181324, an aperture stop and a focus ring are controlled based on a defocus amount of the face and that of the arm that hides the face, which makes it possible to put a focus on both the face and the arm that hides the face. However, in consideration of time associated with processing and driving of an apparatus, it is difficult to adjust a depth of field every time in a situation where a user wants a subject moving at high speed or a subject moving in an unpredicted manner to fall within the depth of field.

### SUMMARY

The present disclosure is directed to providing an imaging apparatus that maintains a state where the imaging apparatus focuses on a target subject regardless of movement of a subject.

According to an aspect of the present disclosure, an imaging apparatus includes at least one processor and at least one memory storing a program, which when executed by the at least one processor, causes the imaging apparatus to capture an image of a subject, output a first defocus range corresponding to a first portion of the subject and a second defocus range corresponding to a second portion of the subject, and set an imaging condition with respect to the subject based on the first defocus range at a first time, the first defocus range at a second time, the second defocus range at the first time, and the second defocus range at the second time.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a hardware configuration of an imaging apparatus.

FIG. 2 is a diagram illustrating an imaging optical system for describing a defocus amount in the imaging apparatus.

FIG. 3 is a block diagram illustrating a configuration of the imaging apparatus to which the present disclosure is applicable.

FIGS. 4A and 4B are diagrams illustrating a defocus range.

FIG. 5 illustrates a flowchart of estimation of an imaging condition according to a first embodiment.

FIGS. 6A to 6D are schematic diagrams illustrating imaging condition estimation processing according to the first embodiment.

FIG. 7 illustrates a flowchart of estimation of an imaging condition according to a second embodiment.

### DESCRIPTION OF THE EMBODIMENTS

The following description is provided based on favorable embodiments of the present disclosure with reference to the accompanying drawings. Configurations described in the following embodiments are merely examples, and the present disclosure is not limited to the configurations illustrated in the drawings.

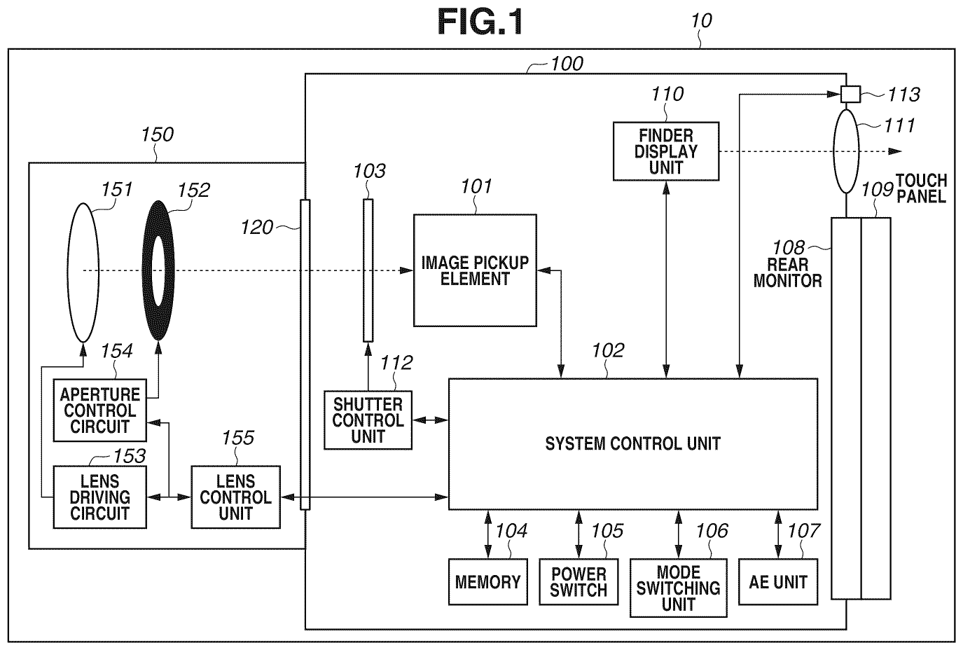

Configurations common to the embodiments are described with reference to FIGS. 1, 2, 3, 4A, and 4B. An interchangeable lens digital camera is described below as an example of an imaging apparatus according to the present disclosure.

FIG. 1 is a block diagram illustrating a main portion of a system of an imaging apparatus 10. The imaging apparatus 10 is, for example, an interchangeable lens digital camera, and is configured to include a camera main body 100 and a lens unit 150 that guides incident light to an image pickup element 101 included in the camera main body 100.

The camera main body 100 includes the image pickup element 101, a system control unit 102, a shutter 103, a memory 104, a power switch 105, a mode switching unit 106, a rear monitor 108, a touch panel 109, and a finder display unit 110. The camera main body 100 also includes an eyepiece lens 111, an eye-contact detection unit 113, a shutter control unit 112, and a lens mount mechanism 120.

The image pickup element 101 is, for example, a complementary metal-oxide semiconductor (CMOS) image sensor, and converts an optical signal as an optical image into an electric signal. Light rays incident on an imaging lens 151 in the lens unit 150 pass through an aperture stop 152 and the shutter 103, and are formed as an optical image on the image pickup element 101.

The system control unit 102 has a central processing unit (CPU) or the like, and controls the camera main body 100. The system control unit 102 includes an image processing unit that processes a video signal obtained in the image pickup element 101. The system control unit 102 also includes a phase difference auto focus (AF) unit that performs focus detection processing using a phase difference detection method based on image data for focus detection (signal for phase difference AF) obtained from the image pickup element 101 and the image processing unit. More specifically, the image processing unit generates a pair of image data formed of light fluxes that pass through a pair of pupil areas in the imaging optical system as image data for focus detection. The phase difference AF unit detects a defocus amount based on a shift amount between the pair of image data. This enables the phase difference AF unit according to the present disclosure to perform imaging plane phase difference AF based on output of the image pickup element 101 without using a dedicated AF sensor.

The memory 104 stores a program, variables, constants, and the like for an operation of the system control unit 102. The memory 104 also includes an electrically erasable and storable non-volatile memory.

The memory 104 also stores various types of parameters, setting values such as International Standards Organization (ISO) sensitivity, an imaging mode, various kinds of correction data, and the like.

The power switch 105 performs mode switching to power ON or OFF the camera main body 100.

The mode switching unit 106 is a switch to set switching to an imaging mode of various types such as live-view imaging or moving-image capturing. Examples of modes included in a still-image capturing mode include an auto imaging mode, a manual mode, an aperture priority mode (an aperture value (Av) mode), a shutter speed priority mode (time value (Tv) mode), and a program auto exposure (AE) mode (program (P) mode).

An AE unit 107 is an exposure control unit that performs exposure control processing to obtain an appropriate imaging condition based on a signal for AE obtained from the image pickup element 101 and the image processing unit. The AE unit 107 calculates an exposure amount with a set aperture value, set shutter speed, or set ISO sensitivity based on the signal for AE. The AE unit 107 calculates an appropriate aperture value, appropriate shutter speed, and appropriate ISO sensitivity to be set at the time of imaging from a difference between the calculated exposure amount and a preliminarily set appropriate exposure amount, sets the calculated aperture value, the calculated shutter speed, and the calculated ISO sensitivity as an imaging condition, and thereby performs the exposure control processing.

The rear monitor 108 includes a liquid crystal device and light-emitting diodes (LEDs). The liquid crystal device displays texts, an image, an operation state such as voice, and imaging information such as a message in response to execution of a program by the system control unit 102.

The touch panel 109 is disposed in an area substantially identical to that of the rear monitor 108, detects a touch of an operator's finger or a pen, notifies the system control unit 102 of a touch position on the rear monitor 108, and executes an operation or a function associated with the touch position.

The finder display unit 110 displays imaging information in response to execution of the program in the system control unit 102 similarly to the rear monitor 108, and constitutes an electronic view finder (EVF) together with the eyepiece lens 111.

The eye-contact detection unit 113 detects an eye-contact state of an operator. The system control unit 102 selectively displays the above-mentioned imaging information on the rear monitor 108 or the finder display unit 110 depending on the eye-contact state of the operator.

A configuration of the lens unit 150 will now be described. The camera main body 100 and the lens unit 150 are mechanically and electrically bonded together via the lens mount mechanism 120, and the lens unit 150 is detachably mounted on the camera main body 100. The lens unit 150 includes the imaging lens 151, the aperture stop 152, a lens driving circuit 153, an aperture control circuit 154, and a lens control unit 155. In FIG. 1, only one imaging lens 151 is illustrated for simplicity, but the imaging lens 151 is typically composed of a plurality of imaging lens groups.

The aperture stop 152 is a mechanism to adjust a quantity of light incident on the image pickup element 101 via a lens and is controlled by the aperture control circuit 154.

The lens driving circuit 153 is a driving circuit to move a lens on an optical axis to adjust a focus position on an imaging screen.

The lens control unit 155 controls the lens unit 150. The lens control unit 155 includes a memory (not illustrated) that stores various types of constants, variables, a program, and the like for a lens operation.

The lens control unit 155 also includes a non-volatile memory that stores maximum and minimum aperture values, a focal length, and the like, which are lens unit-specific information.

The system control unit 102 in the camera main body 100 calculates a defocus amount using output information from the image pickup element 101. The system control unit 102 performs communication via the lens control unit 155 in the lens unit 150, and controls the lens driving circuit 153 based on the calculated defocus amount to perform focusing.

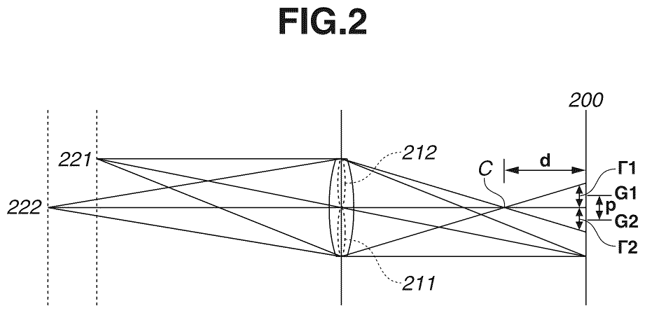

The defocus amount used as image depth information in the present disclosure is described with reference to FIG. 2. More specifically, FIG. 2 is a diagram illustrating a relationship between a defocus amount of the imaging optical system and a phase difference (image shift amount) between a first focus detection signal and a second focus detection signal that are acquired from an image pickup element.

The image pickup element (not illustrated) is disposed on an imaging plane 200 in FIG. 2, and an exit pupil of the imaging optical system is divided into a first pupil area 211 and a second pupil area 212. A defocus amount d indicates a distance from an image formation position C to the imaging plane 200. The image formation position C is a position where light fluxes from subjects 221 and 222 converge to form an image. Assume that an absolute value of the distance is |d|. A state where the image formation position Cis on the subject side of the imaging plane 200 is called a front-focus state, and the defocus amount is expressed as a negative value (d<0). A state where the image formation position C goes beyond the imaging plane 200 and is on the opposite side of the subject is called a back-focus state, and the defocus amount is expressed as a positive value (d>0). In an in-focus state where the image formation position C is on the imaging plane 200, d is 0 (d=0). The imaging optical system illustrated in FIG. 2 is in the in-focus state (d=0) with respect to the subject 221, and is in the front-focus state (d<0) with respect to the subject 222. The front-focus state (d<0) and the back-focus state (d>0) are collectively referred to as a defocus state (|d|>0).

In the front-focus state (d<0), part of light fluxes from the subject 222 passes through the first pupil area 211 and converges, and is thereafter formed on the imaging plane 200 as a blurred image that spreads to have a width Γ1 centering on a centroid position G1 of light fluxes. Light of the blurred image is received by each first focus detection pixel on the image pickup element, and a first focus detection signal is generated. That is, the first focus detection signal is a signal indicating a subject image in which the subject 222 is blurred by a blur width Γ1 at the centroid position G1 of the light fluxes on the imaging plane 200. Similarly, part of light fluxes from the subject 222 passes through the second pupil area 212 and converges, and is thereafter formed on the imaging plane 200 as a blurred image that spreads to have a width Γ2 centering on a centroid position G2 of light fluxes. Light of the blurred image is received by each second focus detection pixel on the image pickup element, and a second focus detection signal is generated. That is, the second focus detection signal is a signal indicating a subject image in which the subject 222 is blurred by a blur width Γ2 at the centroid position G2 of light fluxes on the imaging plane 200.

The blur widths Γ1 and Γ2 of the subject image increase in approximate proportion to an increase of the value |d| of the defocus amount d. Similarly, a value |p| of an image shift amount p between the first focus detection signal and the second focus detection signal, which is a difference between the centroid positions of the light fluxes (G1-G2), also increases in approximate proportion to the increase of the value |d| of the defocus amount d.

In the back-focus state, a direction of an image shift between the first focus detection signal and the second focus detection signal is opposite to that in the front-focus state. A relationship among the defocus amount, the blur width, and the image shift in the back-focus state are similar to that in the front-focus state.

As described above, the value |p| of the image shift amount p between the first focus detection signal and the second focus detection signal increases in approximate proportion to the increase of the value |d| of the defocus amount d. In the present disclosure, a focus detection is performed using an imaging plane phase difference detection method in which the defocus amount d is calculated from the image shift amount p between the first focus detection signal and the second focus detection signal obtained with use of the image pickup element 101. Thus, the phase difference AF unit in the system control unit 102 converts the image shift amount p into the detection defocus amount d.

A transformation coefficient is calculated from a baseline length based on the relationship that the value |p| of the image shift amount p between the first focus detection signal and the second focus detection signal increases in approximate proportion to the increase of the value |d| of the defocus amount d of an imaging signal. A product [Fδ] of a f-stop number and a permissible circle of confusion δ in an optical system of an imaging apparatus at the time of imaging is used as a unit of the defocus amount d in the present disclosure.

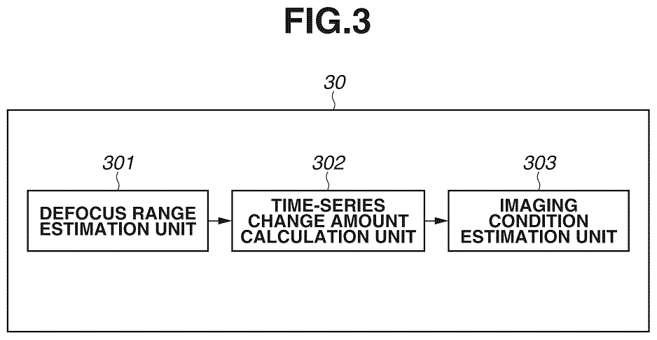

FIG. 3 is a block diagram illustrating an imaging apparatus 30 that implements the present disclosure. The imaging apparatus 30 is a multi-purpose imaging apparatus including the configuration of the imaging apparatus 10. The imaging apparatus 30 includes a defocus range estimation unit 301, a time-series change amount calculation unit 302, and an imaging condition estimation unit 303, and is controlled by a CPU of the system control unit 102, or the like.

The defocus range estimation unit 301 estimates a defocus range of a subject as described below.

The time-series change amount calculation unit 302 calculates temporal fluctuations such as the defocus range of the subject, which is estimated by the defocus range estimation unit 301.

The imaging condition estimation unit 303 estimates an imaging condition based on fluctuations in the defocus range, which are detected by the time-series change amount calculation unit 302. The AE unit 107 may perform exposure control processing based on the imaging condition estimated by the imaging condition estimation unit 303.

The imaging apparatus 30 executes exposure control processing based on the estimation of the defocus range, and selects the imaging condition based on the movement of the subject depending on a result of estimation of the defocus range.

As described above, the defocus range estimation unit 301 estimates the defocus range of the subject.

The defocus range is a range of the defocus amount of the subject.

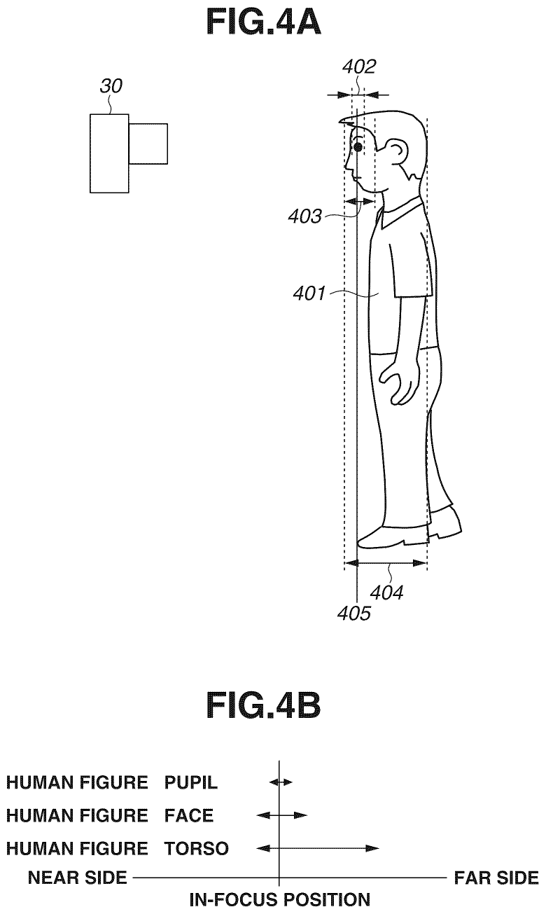

FIGS. 4A and 4B are diagrams illustrating the defocus range. FIG. 4A illustrates a state where an image of a human FIG. 401 is captured with use of the imaging apparatus 30. FIG. 4A illustrates respective breadths of a pupil 402 of the human FIG. 401, a face 403 of the human FIG. 401, and a torso 404 of the torso of the human FIG. 401 as breadths of an object in the depth direction viewed from the imaging apparatus 30. An in-focus position 405 of the imaging apparatus 30 indicates that the imaging apparatus 30 comes into focus at the position of the pupil 402 of the human FIG. 401.

FIG. 4B schematically illustrates defocus ranges estimated with respect to the pupil 402 of the human FIG. 401, the face 403 of the human FIG. 401, and the torso 404 of the human FIG. 401. An abscissa axis direction in FIG. 4B indicates a value of the defocus amount, and a length of a line segment indicates a defocus range, which is a range of the defocus amount. A near side with respect to the imaging apparatus 30 is referred to as a near side, and a far side with respect to the imaging apparatus 30 is referred to as a far side.

In FIG. 4A, for example, as the breadth of the torso 404 of the human FIG. 401 in the depth direction viewed from the imaging apparatus 30, the nearest side is located on the tip of the nose of the human FIG. 401 and the farthest side is located on the tip of the shoulder of the human FIG. 401. Thus, a maximum value (a nearest side value) of the defocus amount of the torso 404 of the human FIG. 401 is a defocus amount indicating the tip of the nose of the human FIG. 401, and a minimum vale (a farthest side value) of the defocus amount is a defocus amount indicating the tip of the shoulder of the human FIG. 401. A range defined by the maximum value to the minimum value is the defocus range of the torso 404 of the human FIG. 401.

A line segment corresponding to the torso 404 of the human FIG. 401 in FIG. 4B indicates these relationships of the defocus range, and the nearest side value of the defocus value of the torso 404 is, for example, 0.2 Fδ, and the farthest side value of the defocus value of the torso 404 is, for example, −1.4 Fδ. The defocus range estimation unit 301 estimates the defocus range in consideration of a distance relationship in the depth direction of an estimation target such as the pupil of the subject and the torso of the subject.

The defocus range estimation unit 301 according to the present disclosure takes input of a subject image and a defocus map, and outputs the defocus range of the subject. The defocus map is information regarding defocus amount distribution in which the defocus amount is allocated to a certain number of pixels on the imaging plane 200. The defocus range estimation unit 301 distinguishes the subject seen in the image, and estimates the defocus range of the entire subject or each part such as the pupil of the subject, the face of the subject, and the torso of the subject.

The defocus range estimation unit 301 is trained by machine learning using training data as input data. Examples of a specific algorithm of machine learning include deep learning that uses a neural network to generate a feature amount and a connection weight coefficient for training by itself.

Training of the defocus range estimation unit 301 is performed using training data including training images, the defocus map, and a correct answer defocus range as input data. The training of the defocus range estimation unit 301 in the present disclosure is error detection processing and weight updating processing.

In the error detection processing, an error between supervisory data and output data output from an output layer of the neural network is obtained in response to input of input data to an input layer. The correct answer defocus range is used as the supervisory data. In the error detection processing, an error between the output data output from the neural network and the supervisory data may be calculated using a loss function.

In the weight updating processing, the connection weight coefficient between nodes in the neural network and the like are updated to reduce the error obtained in the error detection processing. In the weight updating processing, for example, a backpropagation method is used.

The output data output resulting from such training is a result of estimation of the defocus range.

Thus, it is possible to estimate the defocus range using the machine learning model trained by the above-mentioned training method.

The following description is of a case where the trained machine learning model is applied to the interchangeable lens digital camera as the imaging apparatus. Input data to the machine learning model is, for example, an image captured by the imaging apparatus and the defocus map. Output data is an inference result from the machine learning model, and an estimation value of the defocus range of the subject is output.

### First Embodiment

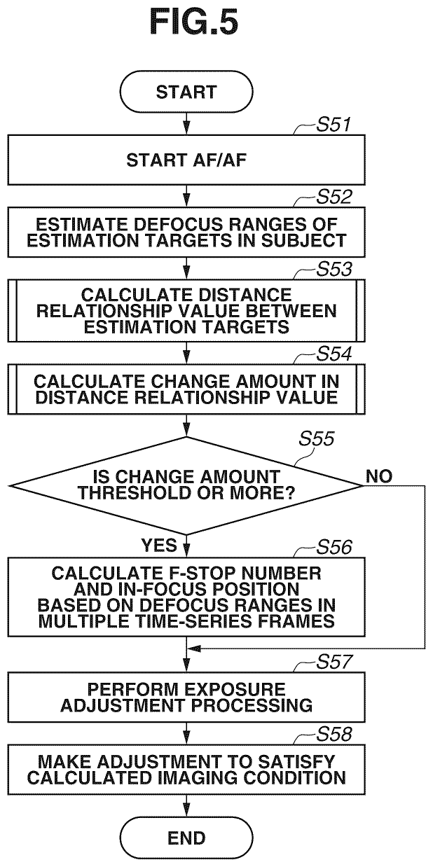

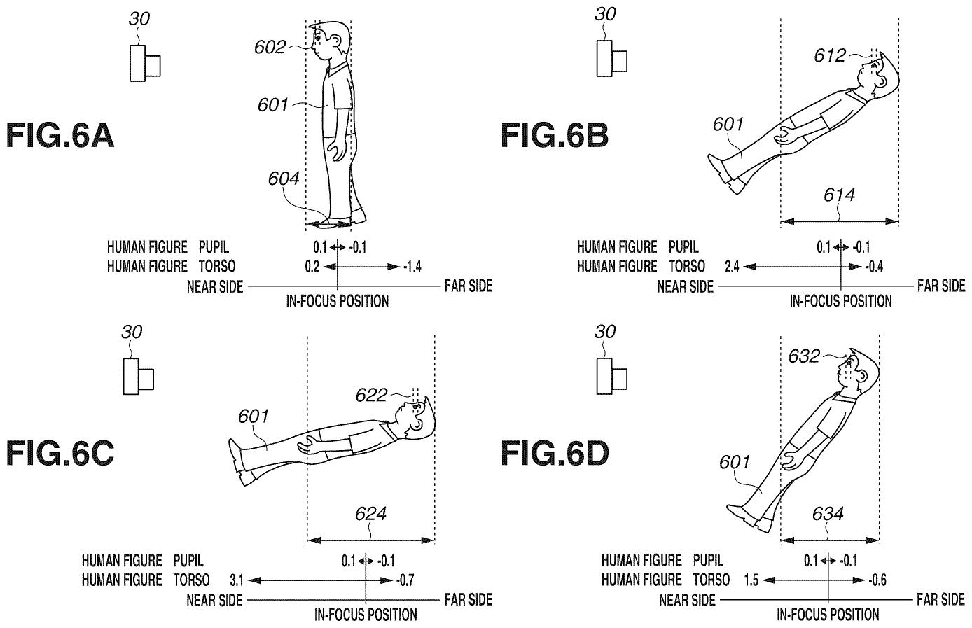

A first embodiment of the present disclosure will now described with reference to FIGS. 5 and 6A to 6D. In the first embodiment, the imaging condition estimation unit 303 estimates an f-stop number and an in-focus position in the optical system of the imaging apparatus 30 at the time of imaging, while the system control unit 102 sets an imaging condition based on a result of the estimation.

The imaging apparatus 30 according to the present embodiment includes a mode in which the f-stop number is adjusted on a priority basis depending on intensity of the movement of the subject. In this mode, the system control unit 102 sets the f-stop number for the aperture stop 152 in the imaging apparatus 30 and the in-focus position of the imaging lens 151 based on the result of estimation of the defocus range by the defocus range estimation unit 301. The AE unit 107 performs exposure control processing to set shutter speed of the shutter control unit 112 and ISO sensitivity based on the set f-stop number.

In a scene where the imaging apparatus 30 captures an image of the human FIG. 401, the defocus range estimation unit 301 estimates the defocus range of the pupil 402, face 403, and torso 404 of the human FIG. 401. The intensity of the movement of the subject may be determined using distance information based on the defocus range of the torso 404 and a subject distance, or using a distance relationship value based on a relative relationship between defocus ranges of estimation targets.

In the present embodiment, a description is provided of a method of determining the intensity of the movement of the subject using the distance relationship value based on the defocus ranges of the estimation targets. In this method, in a case where the defocus range of the torso 404 is 1, a distance relationship of the pupil 402 of the human FIG. 401 can be expressed by a range from 0 to 1, which enables setting a threshold to determine the intensity.

FIG. 5 illustrates the flowchart of the flow of estimating the f-stop number and the in-focus position.

In S51, the phase difference AF unit starts AF, and the AE unit 107 starts AE. The phase difference AF unit performs AF with the pupil 402 being located at the in-focus position. The pupil 402 is the smallest target from among the estimation targets by the defocus range estimation unit 301. The start condition of AF and AE may be pressing of a button allocated to start AF and AE or half-pressing of a shutter button.

In S52, the defocus range estimation unit 301 estimates defocus ranges of the pupil 402, the face 403, and the torso 404, which are the targets of estimation of the defocus ranges in the human FIG. 401.

In S53, a distance relationship value between the estimation targets is obtained based on the defocus ranges estimated by the defocus range estimation unit 301 in S52. More specifically, a distance relationship between the pupil 402 and the torso 404, which are the smallest target and the largest target, respectively, is obtained from among the targets whose defocus ranges are estimated by the defocus range estimation unit 301, whereby a rough posture of the human FIG. 401 in the depth direction is obtained. The distance relationship value obtained from the pupil 402 and the torso 404, a position of the pupil 402 in the depth direction (P_eye) with the maximum value being 1 with respect to the farthest side value in the defocus range of the torso 404 can be expressed by the following Equation 1.

$${P}_{eye} = \frac{\vert {eye}_{m i d} = {body}_{min} \vert}{\vert {body}_{max} = {body}_{min} \vert} \qquad [ Equation 1 ]$$

The symbols of Equation 1 represent the following:
eye_mid: a median value between the farthest side value of the pupil 402 and the nearest side value of the pupil 402.
body_min: the farthest side value of the torso 404.
body_max: the nearest side value of the torso 404.
   That is, the distance relationship value between the pupil 402 and the torso 404 represents the position of the pupil 402 in the defocus range of the torso 404 at the median value between the farthest side value and the nearest side value in the defocus range of the pupil 402 using a ratio in the defocus range of the torso 404.

As the defocus ranges estimated in S52, assume that, for example, the nearest side value of the pupil 402 is 0.1 Fδ, the farthest side value of the pupil 402 is −0.1 Fδ, the nearest side value of the torso 404 is 0.2 Fδ, and the farthest side value of the torso 404 is −1.4 Fδ. The position of the pupil 402 in the depth direction (P_eye) can be expressed as 0.875 using the above-described Equation 1. This means that the pupil 402 is located at 0.875/1 with respect to the farthest side value of the torso 404.

In S54, the time-series change amount calculation unit 302 calculates a temporal change in the distance relationship between the estimation targets, which is calculated in S53. More specifically, the time-series change amount calculation unit 302 calculates an amount of change between a distance relationship value in a present frame and a distance relationship value in a previous frame. The time-series change amount calculation unit 302 may calculate the amount of change using a change rate between the distance relationship value in the present frame and the distance relationship value in the previous frame or using a least-square method, or may calculate the amount of change from dispersion or a correlation coefficient of the distance relationship value in the present frame and the distance relationship value in the previous frame.

In S55, determination is made whether the amount of change detected by the time-series change amount calculation unit 302 is a threshold or more. In a case where it is determined that the amount of change detected by the time-series change amount calculation unit 302 is the threshold or more (YES in S55), the subject is determined to be a subject moving vigorously in the depth direction and whose movement is difficult to be predicted, and the processing proceeds to S56. In S56, the imaging condition estimation unit 303 calculates the f-stop number and the in-focus position to obtain a depth of field based on the amount of change. In a case where it is determined that the amount of change detected by the time-series change amount calculation unit 302 is less than the threshold (NO in S55), the processing proceeds to S57. In S57, the exposure control processing is performed with respect to the f-stop number, the shutter speed, and the ISO sensitivity similarly to the auto imaging mode.

FIGS. 6A to 6D schematically illustrate details of processing of calculating the f-stop number and the in-focus position from S53 to S56 in the present embodiment. FIGS. 6A to 6D illustrate a series of scenes, where FIGS. 6B and 6C illustrate a scene where a human FIG. 601 illustrated in FIG. 6A performs an action of leaning backward, and FIG. 6D illustrates a scene where the human FIG. 601 performs an action of getting up. The orientation of the human FIG. 601 viewed from the imaging apparatus 30 at a fixed position changes vigorously. As a result, the defocus ranges of the estimation targets for the human FIG. 601 also change vigorously.

FIG. 6A illustrates a state where an image of the human FIG. 601 is captured using the imaging apparatus 30 at a time t. A line diagram in the lower part of FIG. 6A schematically illustrates the defocus range of each estimation target for the human FIG. 601. The image of the human FIG. 601 is captured in an upright posture at the time t. A pupil 602 and a torso 604 represent visualized breadths of the object in the depth direction with respect to the imaging apparatus 30 at the time t. In an example where the nearest side value of the defocus range of the pupil 602 is 0.1 Fδ, the farthest side value of the defocus range of the pupil 602 is −0.1 Fδ, the nearest side value of the defocus range of the torso 604 is 0.2 Fδ, and the farthest side value of the defocus range of the torso 604 is −1.4 Fδ, the distance relationship value between the pupil 602 and the torso 604 (P_(eye_t)) can be expressed as 0.875 using Equation 1.

FIG. 6B illustrates a state where the image of the human FIG. 601 is captured using the imaging apparatus 30 at a time t+1. The image of the human FIG. 601 is captured in a prone posture. A pupil 612 and a torso 614 represent visualized breadths of the objects in the depth direction at the time t+1. In an example where the nearest side value of the defocus range of the pupil 612 is 0.1 Fδ, the farthest side value of the defocus range of the pupil 612 is −0.1 Fδ, the nearest side value of the defocus range of the torso 614 is 2.4 Fδ, and the farthest side value of the defocus range of the torso 614 is −0.4 Fδ, the distance relationship value between the pupil 612 and the torso 614 (P_(eye_(t+1))) can be expressed as 0.143 using Equation 1.

FIGS. 6C and 6D illustrate imaging states at a time t+2 and a time t+3, respectively. A pupil 622 and a torso 624 in FIG. 6C are the pupil and torso of the human FIG. 601 at the time t+2, and the defocus range of the pupil 622 is from 0.1 Fδ to −0.1 Fδ and the defocus range of the torso 624 is from 3.1 Fδ to −0.7 Fδ at the time t+2. The distance relationship value between the pupil 622 and the torso 624 (P_(eye_(t++2))) can be expressed as 0.184 using Equation 1. A pupil 632 and a torso 634 illustrated in FIG. 6D are the pupil and torso of the human FIG. 601 at the time t+3. The defocus range of the pupil 632 is from 0.1 Fδ to −0.1 Fδ and the defocus range of the torso 634 is from 1.5 Fδ to −0.6 Fδ at the time t+3. The distance relationship value between the pupil 632 and the torso 634 (P_(eye_(t++3))) can be expressed as 0.286 using Equation 1.

Assuming the present time is the time t+3, the time-series change amount calculation unit 302 calculates an amount of a temporal change in distance relationship values based on distance relationship values in previous three frames from the time t to the time t+3. The distance relationship values in the previous three frames are P_(eye_t), P_(eye_(t+1)), P_(eye_(t+2)), and P_(eye_(t+3)). Assuming an average value of change rates of the distance relationship values from the time t to the time t+3 with the time t+3 is a base point, an amount of change from the time t to the time t+3 can be expressed as 40.2.

When an absolute value of the amount of change exceeds a certain threshold, it is determined that a temporal change in posture of the human FIG. 601 is large. In this case, the imaging condition estimation unit 303 estimates an imaging condition based on the movement of the human FIG. 601. The time-series change amount calculation unit 302 calculates the amount of change from the change rates in the plurality of frames, which enables the imaging condition estimation unit 303 to estimate the imaging condition in consideration of an outlier of estimation made by the defocus range estimation unit 301 and processing time associated with focus control of the imaging lens 151. In other words, the imaging condition estimation unit 303 sets a first imaging condition in a case where the absolute value of the amount of change exceeds the threshold, and sets a second imaging condition in a case where the absolute value is less than or equal to the threshold.

Returning to FIG. 5, in S56, the imaging condition estimation unit 303 estimates the f-stop number of the aperture stop 152 and the in-focus position of the imaging lens 151 based on the defocus ranges estimated by the defocus range estimation unit 301 and the amount of change calculated by the time-series change amount calculation unit 302. In the present embodiment, the imaging condition estimation unit 303 sets, as the in-focus position, a defocus amount at the center of each of the defocus ranges at the time t and the time t+2, at which a difference in defocus ranges calculated by the defocus range estimation unit 301 becomes maximum, and calculates a lens driving amount necessary for control of the imaging lens 151. Additionally, in the estimation of the f-stop number, the imaging condition estimation unit 303 adjusts the quantity of light and the depth of field. For example, the imaging condition estimation unit 303 estimates the f-stop number so that the nearest side value of the defocus amount at the time t and the farthest side value of the defocus amount at the time t+2 fall within a unit of depth that is determined by a permissible circle of confusion.

In S57, the AE unit 107 performs exposure control processing based on the f-stop number for the aperture stop 152, which is estimated in S56.

In S58, the imaging condition adjustment unit adjusts the imaging condition to satisfy the condition estimated in S56 and S57, and captures an image of the subject. The estimated imaging condition may be presented to a user via the rear monitor 108 or the finder display unit 110. Whether the estimated imaging condition is used for imaging may be determined by the user's operation.

As described above, in the present embodiment, the imaging condition is set based on the temporal change in the result of estimation of the defocus range. This can be put otherwise as follows assuming that the pupil is a first portion, the torso is a second portion, the defocus range of the pupil is a first defocus range, and the defocus range of the torso is a second defocus range. In the present embodiment, a first distance relationship value based on the first defocus range and the second defocus range at the first time is calculated. Additionally, a second distance relationship value based on the first defocus range at the second time and the second defocus range at the second time is calculated. The imaging condition with respect to the subject is set based on the first distance relationship value and the second distance relationship value. That is, the imaging condition with respect to the subject is set based on the first defocus range at the first time, the first defocus range at the second time, the second defocus range at the first time, and the second defocus range at the second time. This configuration enables capturing an image in which the subject is correctly in focus in consideration of the movement of the subject.

The imaging apparatus 30 according to the present embodiment has a configuration in which the AE unit 107 performs exposure control processing and adjusts shutter speed and ISO sensitivity. The configuration of the imaging apparatus 30 to perform exposure control processing without the user's control is merely an example, and the imaging apparatus 30 may be configured to perform fine adjustment of the imaging condition based on, for example, the shutter speed or the ISO sensitivity set by the user. Additionally, the above description was directed to a case where the distance relationship value is calculated from the change in results of estimation of the defocus ranges of the pupil and torso of the human figure as the subject and the imaging condition is estimated. Defocus ranges used for estimation of the imaging condition are not limited thereto. For example, results of estimation of defocus ranges of the face and torso of the human figure may be used, or results of estimation of defocus ranges of at least part of the human figure and a result of estimation of a defocus range of an object attached to the human figure may be used. The object carried by the human figure is, for example, a racket or a pole for pole vaulting.

### Modification of First Embodiment

In the above-described first embodiment, the imaging condition estimation unit 303 estimates the imaging condition based on the values calculated from S53 to S57. The method of estimating the imaging condition is not limited thereto. For example, the imaging condition may be estimated in consideration of the movement of the subject using an imaging condition estimation device that takes input of an image in a frame at the present time, an image in a previous frame, and defocus ranges estimated at respective times, and that outputs the imaging condition.

The imaging condition estimation device is trained by machine learning using training data as input data. Examples of a specific algorithm of machine learning include deep learning that uses a neural network to generate a feature amount and a connection weight coefficient for training by itself. The estimation result to be output as a result of training is the imaging condition in consideration of the movement of the subject in the imaging apparatus 30.

### Second Embodiment

A second embodiment of the present disclosure is directed to a method in which the imaging condition estimation unit 303 estimates shutter speed of the imaging apparatus 30 at the time of imaging and the system control unit 102 sets the imaging condition. The following description will primarily focus on elements different from the first embodiment, where a description of configurations common to the first embodiment is omitted.

Assume that the imaging apparatus 30 according to the present embodiment includes a mode in which shutter speed is adjusted on a priority basis depending on the movement of the subject. In this mode, shutter speed of the shutter control unit 112 in the imaging apparatus 30 is set on a priority basis based on a result of estimation by the defocus range estimation unit 301. The AE unit 107 performs exposure control processing to set the f-stop number of the aperture stop 152 and the ISO sensitivity based on the set shutter speed.

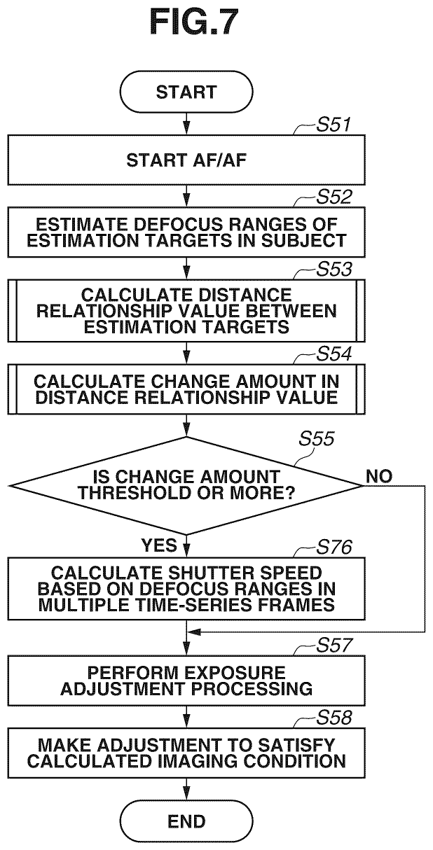

FIG. 7 is a flowchart illustrating the flow of estimation of the shutter speed. The estimation flow in the flowchart illustrated in FIG. 5 is applicable to the present embodiment, where implementation the flow of estimation according to the second embodiment occurs by replacing S56 in FIG. 5 with S76, which will be described below. Since the processing from S51 to S54 is in common with the flowchart in FIG. 5, a description thereof is omitted and processing in S55 or subsequent steps is described.

In S55, determination is made whether the amount of change detected by the time-series change amount calculation unit 302 is a threshold or more. In a case where it is determined that the amount of change is greater than or equal to the threshold (YES in S55), the subject is determined to be a subject moving vigorously in the depth direction and whose movement is difficult to be predicted, and the processing proceeds to S76.

In S76, the imaging condition estimation unit 303 calculates shutter speed based on speed of the subject. The imaging condition estimation unit 303 estimates the shutter speed of the shutter control unit 112 based on the defocus ranges estimated by the defocus range estimation unit 301 and the amount of change calculated by the time-series change amount calculation unit 302. In the present embodiment, the imaging condition estimation unit 303 calculates the shutter speed by obtaining speed of each estimation target in the depth direction based on the defocus ranges estimated by the defocus range estimation unit 301 and a distance of the subject to the in-focus position.

In a case where it is determined that the amount of change detected by the time-series change amount calculation unit 302 is less than the threshold (NO in S55), the processing proceeds to S57. In S57, the exposure control processing is performed with respect to the f-stop number, the shutter speed, and the ISO sensitivity similarly to the auto imaging mode.

A description will now be provided of a method of estimating shutter speed at which the subject is not blurred based on speed of the subject in a horizontal direction and a vertical direction. The speed of the subject in the horizontal direction and the vertical direction can be calculated from a size of the image pickup element 101, a frame rate (frames per second: fps) of the image pickup element 101 to output video signals, a focal length, and a subject distance. An angle of view (viewing angle) can be calculated based on the size of the image pickup element 101 and the focal length. Movement distances of the subject in the horizontal direction and the vertical direction are calculated based on the angle of view. Movement distances in the horizontal direction and the vertical direction in consecutive multiple frames, which are obtained from the image pickup element 101, are added and an aggregate total is divided by the used number of frames, whereby average speed of the subject can be calculated.

The speed of the subject in the horizontal direction and the vertical direction is converted in terms of the size of the image pickup element 101. The subject straddles pixels in the image pickup element 101 within exposure time, whereby so-called blurring occurs. Thus, the shutter speed at which the subject does not straddle pixels in the image pickup element 101 within the exposure time is calculated based on the speed of the subject in the horizontal direction and the vertical direction, which makes it possible to implement the shutter speed at which the subject is not blurred.

As described above, it is possible to calculate the shutter speed at which the subject is not blurred based on the speed of the subject in the horizontal direction and the vertical direction. Further calculating the speed in the depth direction enables determining the shutter speed in consideration of blurring in the horizontal direction and the vertical direction even in a case where the movement occurs in the horizontal direction and the vertical direction at speed equal to the speed in the depth direction. The movement distance of the subject in the depth direction can be calculated from the defocus ranges estimated by the defocus range estimation unit 301 and the subject distance. A distance from the imaging apparatus 30 to the estimation target is calculated with respect to each of the nearest side value and the farthest side value of the defocus amount of the estimation target, based on a unit of depth determined by a permissible circle of confusion and the subject distance. The nearest side distance and farthest side distance of the estimation target are averaged, and an average value serves as the distance from the imaging apparatus 30 to the estimation target. Movement distances in the horizontal direction and the vertical direction in consecutive multiple frames, which are obtained from the image pickup element 101, are added and an aggregate total is divided by the used number of frames, whereby average speed of the subject can be calculated.

The speed of the subject in the depth direction is converted in terms of the size of the image pickup element 101. The shutter speed at which the subject image does not straddle pixels in the image pickup element 101 in the horizontal direction and the vertical direction with use of the speed of the subject in the depth direction converted in terms of the size of the image pickup element 101.

According to the present embodiment, setting the shutter speed in consideration of the movement of the subject enables capturing an image in which the subject is not blurred.

### Other Embodiments

While details of the embodiments have been described above, the present disclosure can be implemented, for example, as embodiments such as a system, an apparatus, a method, a program, or a recording medium (storage medium). Specifically, the present disclosure may be applied to a system composed of a plurality of devices (for example, a host computer, an interface device, an imaging apparatus, and a web application) or an apparatus composed of a single device.

Aspects of the present disclosure can be achieved by providing a recording medium (or a computer-readable storage medium) in which program codes (computer program) of software that implements functions of the above-mentioned embodiments are recorded is installed in the system or the apparatus. The system or a computer of the apparatus (or a CPU or a microprocessing unit (MPU)) reads out the program codes stored in the recording medium and executes the program codes. In this case, the program codes themselves, which are read out from the recording medium, implement the above-mentioned functions according to the embodiments, and the recording medium that stores the program codes constitutes the present disclosure.

According to the present disclosure, it is possible to maintain a state where the imaging apparatus focuses on a target subject regardless of movement of the subject.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-001666, filed Jan. 6, 2025, which is hereby incorporated by reference herein in its entirety.

What is claimed is:

1. An imaging apparatus comprising:
at least one processor; and
at least one memory storing a program, which when executed by the at least one processor, causes the imaging apparatus to:
capture an image of a subject;
output a first defocus range corresponding to a first portion of the subject and a second defocus range corresponding to a second portion of the subject; and
set an imaging condition with respect to the subject based on the first defocus range at a first time, the first defocus range at a second time, the second defocus range at the first time, and the second defocus range at the second time.

2. The imaging apparatus according to claim 1, wherein the image apparatus is further caused to estimate the imaging condition.

3. The imaging apparatus according to claim 2, wherein the imaging apparatus is further caused to estimate the imaging condition using a trained machine learning model.

4. The imaging apparatus according to claim 2, wherein the imaging apparatus is further caused to set the imaging condition with respect to the subject based on a first distance relationship value based on the first defocus range at the first time and the second defocus range at the first time, and a second distance relationship value based on the first defocus range at the second time and the second defocus range at the second time.

5. The imaging apparatus according to claim 4, wherein the imaging apparatus is further caused to set the imaging condition based on an amount of change in the first distance relationship value and the second distance relationship value.

6. The imaging apparatus according to claim 5, wherein the imaging apparatus is further caused to, in a case where an absolute value of the amount of change exceeds a threshold, set a first imaging condition, and in a case where the absolute value is less than or equal to the threshold, set a second imaging condition.

7. The imaging apparatus according to claim 4, wherein the first distance relationship value represents, as a ratio in the second defocus range, a position in a range from a farthest side value to a nearest side value in the second defocus range at a median value between a farthest side value and a nearest side value in the first defocus range.

8. The imaging apparatus according to claim 1, wherein the imaging apparatus is further caused to present the imaging condition to a user.

9. The imaging apparatus according to claim 1, wherein he imaging apparatus is further caused to set at least one of an aperture stop or an in-focus position regarding the imaging apparatus.

10. The imaging apparatus according to claim 1, wherein the imaging apparatus is further caused to set a shutter speed of the imaging apparatus.

11. The imaging apparatus according to claim 1, wherein the first portion is a pupil of the subject and the second portion is a torso of the subject.

12. The imaging apparatus according to claim 1, wherein the first portion is a face of the subject and the second portion is a torso of the subject.

13. The imaging apparatus according to claim 1, wherein the imaging apparatus is further caused to estimate shutter speed based on speed of the subject in a horizontal direction.

14. A method for an imaging apparatus, the method comprising:
capturing an image of a subject;
performing a defocus range estimation to output a first defocus range corresponding to a first portion of the subject and a second defocus range corresponding to a second portion of the subject; and
setting an imaging condition with respect to the subject based on the first defocus range at a first time, the first defocus range at a second time, the second defocus range at the first time, and the second defocus range at the second time.

15. A non-transitory computer-readable storage medium storing a program that causes a computer to execute the method of claim 14.
